(19) United States
(12) Patent Application Publication
(10) Pub. No.: US 2025/0148423 A1
(43) Pub. Date: May 8, 2025

(54) VIRTUAL CONCIERGE SYSTEM

(71) Applicant: Aircierge, Inc., Redwood City, CA (US)

(72) Inventors: Vivian Love, Redwood City, CA (US); Arash Keshmirian, Redwood City, CA (US); Jesshill Love, Redwood City, CA (US)

(73) Assignee: Aircierge, Inc., Redwood City, CA (US)

(21) Appl. No.: 18/925,773

(22) Filed: Oct. 24, 2024

Related U.S. Application Data
(60) Provisional application No. 63/596,445, filed on Nov. 6, 2023.

(51) Int. Cl. G06Q 10/1093; G06Q 50/14

(52) U.S. Cl. CPC G06Q 10/1093; G06Q 50/14

(57) ABSTRACT

A virtual concierge platform includes an artificial intelligence module operable to automatically generate a suggested list of activities and/or locations within a limited distance of a geolocation of a user device. The suggested list is generated upon the user device scanning at least one unique visual code affixed or cut into at least one physical object. The suggested list is personalized for each user based on received user data from the user device, from social media accounts associated with the user, and/or from other metadata associated with the user.

### CROSS-REFERENCE TO RELATED APPLICATIONS

This application is related to and claims priority from the following US patents and patent applications: this application claims priority from and the benefit of U.S. Provisional Patent Application No. 63/596,445, filed Nov. 6, 2023, which is incorporated herein by reference in its entirety.

### BACKGROUND OF THE INVENTION

### 1. Field of the Invention

The present invention relates to a virtual concierge system, and more specifically to an artificial intelligence-aided platform for providing travelers with information about their stay and suggested activities.

### 2. Description of the Prior Art

It is generally known in the prior art to provide an artificial intelligence system to create suggested activities.

Prior art patent documents include the following:

US Patent Publication No. 2015/0048169 for Carrier Element With A QR Code by inventor Doberschutz, filed Aug. 11, 2014 and published Feb. 19, 2015, is directed to a carrier element with a QR code, including a decorative area having a decorative design with an inner area (1) with the QR code and an outer area (2) that is adjacent to the inner area (1) or at least partially surrounds the inner area. The decorative design has, in the outer area (2), an outer design with pattern sections that are combined from elements of QR codes.

US Patent Publication No. 2022/0360956 for Content Recommendation And Display Based On Geographic And User Context, by inventors Zaltzman, et al., filed Jul. 21, 2022 and published Nov. 10, 2022, is directed to a travel system generating and providing content recommendations to a user of the travel system. The travel system identifies content categories that are likely to be of interest to the user of the travel system based on context characteristics of the user such as whether the user is a traveler or a local at a particular geographic location. Additionally, the travel system further identifies content objects (e.g., attractions, activities, events, restaurants, businesses, and the like) for each identified content category that are likely to be of interest to the user based on characteristics of each content object. The identified content categories and content objects are provided as content recommendations for display to a user of the travel system, enabling a user to quickly navigate between content categories and content objects within each content category.

US Patent Publication No. 2021/0264910 for User-Driven Content Generation For Virtual Assistant, by inventor Young, filed Feb. 26, 2020 and published Aug. 26, 2021, is directed to a computer system with access to a database of curated content receives a content request (e.g., based on words spoken by a human user interacting with a virtual assistant). The content request relates to a feature of a property (e.g., a vacation rental house) or an area in which the property is located. The computer system determines, based on analysis of the content request, that curated content related to the content request is not available in the database. The computer system transmits a representation of the content request to a property host computing device or a location-based search service. The computer system receives content from the host computing device or search service, which is responsive to the content request. The received content may then be presented to a user (e.g., via email, SMS message, or as synthesized voice output generated by the virtual assistant).

U.S. Pat. No. 10,854,026 for System And Method For Premise Management, by inventors Wang, et al., filed Jan. 27, 2020 and issued Dec. 1, 2020, is directed to systems and methods for premise management comprising a reservation 5 management module having at least one server, the at least one server arranged in data communication with a user device to receive a request for reservation from the user device to access a premise for a specific duration; and a key generator arranged in data communication with the reservation management module; wherein upon receipt of the request for reservation, the key generator generates a secret key for 10 the user to access the premise for the specific duration. The system may be integrated with other modules including, but not limited to, a lock system and a presence detection system to provide a seamless service to a user.

US Patent Publication No. 2016/0171533 for Method And Device For Distributing Information To A User Provided With A Communicating Mobile Terminal With Information Filtering And Learning Using Bipartite Graphs Or Neural Networks by inventor Cambot, filed Oct. 18, 2013 and published Jun. 16, 2016, is directed to a method for distributing information to a user equipped with a communicating mobile terminal. Geolocating the terminal to provide information representative of the geographical location of the terminal. The terminal communicates the information representative of the geographical location of the terminal to a server. The server selects stored information according to the information representative of the location of the terminal and predefined location data associated with each piece of information. The server filters the selected information according to a user profile associated with the terminal, sorts the filtered information by a bipartite graph, and transmits the sorted information to the terminal. The terminal displays the transmitted information on a screen. Determining the processing applied by the user to each displayed information according to an interaction of the user with the terminal. Learning, by the bipartite graph, according to the processing applied by the user to each displayed information.

US Patent Publication No. 2023/0281736 for Systems And Methods For Travel Optimization by inventors Freese, et al., filed May 12, 2023 and published Sep. 7, 2023, is directed to methods, systems, and computer-readable media for generating a virtual based on location. The method acquires a request for a service based on a type of service and is associated with a user, the user's location, and user preferences. The method then acquires a set of service providers based on the type of service and the user's location who are filtered from a larger set of service providers using user preferences. The method in the next step acquires a machine learning model that is based on stored information associated with other users travel patterns and with service providers providing the service and the geographical information associated with the user's location. The method executed the identified machine learning model to aggregate a subset of service providers based on output from the machine learning model. The machine learning model is inputted the set of service providers, the user's location, the user's preferences, and the geographical information.

US Patent Publication No. 2014/0129453 for Personal Concierge On Mobile Computing Device by inventor Brazell, filed Jun. 25, 2013 and published May 8, 2014, is directed to methods, systems, and computer program products for providing a personal concierge to guests of a hotel or other establishment. The personal concierge can be provided in the form of a mobile application. The mobile application can be executed on a guest's mobile phone or other mobile electronic device so that the personal concierge can continuously assist the guest. The personal concierge can interface with various devices within or around a hotel such as the devices within a guest's room. The personal concierge can be configured to identify a guest's preferences or habits to better provide suggestions or assistance during a stay.

US Patent Publication No. 2023/0044482 for Expandable personalized travel dashboard by inventors Hallivis, et al., filed Apr. 1, 2022 and published Feb. 9, 2023, is directed to a system and method for assisting an individual to plan a trip, wherein the system can act as a travel companion to guide the individual on the trip. The system includes an AI module that can learn travel preferences of the individual. An aggregation module can get travel-related data from third party servers and databases and uses an AI model generated by the AI module to analyze the data, presenting relevant information to the individual. A planning module can act as a travel companion by knowing current location of the individual and present timely information to the individual.

US Patent Publication No. 2017/0032480 for Personalized Travel Planning And Guidance System by inventors Wong, et al., filed Aug. 1, 2016 and published Feb. 2, 2017, is directed to a system and method for providing a personalized travel planning and guidance to the user. The system may predict user's travel behavior based upon multiple inputs. The system may identify tourist attractions on a route matching with the user's travel behavior. The system may cluster the tourist attractions into different clusters. The system may compute shortest paths and predetermined durations for one or more tourist attractions associated to each cluster. The system may display a route and time schedule as a travel itinerary on a display device of the user. The system may predict deceleration of vehicle and provide a warning to the user if the deceleration value exceeds a predefined threshold. The system may further compute a safe optimal distance to decelerate the vehicle while entering a curve on the route and provide another warning to the user if the vehicle position is within the safe optimal distance.

U.S. Pat. No. 11,205,196 for Systems And Methods For Generating Travel-Related Recommendations Using Electronic Communication Data by inventor Raviv, filed Jul. 3, 2019 and issued Dec. 21, 2021, is directed to systems and methods for generating recommendations to users based on historical travel information and electronic communication data. The disclosed systems and methods provide a novel framework for automating the transmission of electronic travel-related recommendations to users by consistently monitoring electronic messages received at an electronic communication mailbox corresponding to a user. The disclosed framework operates by leveraging historical user data, data parsed from electronic communication mailbox corresponding to a user, or various vendor information, and using the aforementioned data as inputs for travel-related recommendation models, in order to generate and transmit the optimal travel-related recommendations to a user.

U.S. Pat. No. 8,954,425 for Snippet Extraction And Ranking by inventors Xiao, et al., filed Jun. 8, 2010 and issued Feb. 10, 2015, is directed to a technology that facilitates efficient automated mining of topic-related aspects of user-generated content based on automated analysis of the user-generated content. Locations are automatically learned based on dividing documents into document segments, and decomposing the segments into local topics and global topics. Techniques are described that facilitate automatically extracting snippets. These techniques include, for example, computer annotating travelogues with learned tags and images, performing topic learning to obtain an interest model, performing location matching based on the interest model, calculating geographic and semantic relevance scores, ranking snippets based on the geographic and semantic relevance scores, and searching snippets with a “location+context term” query.

U.S. Pat. No. 11,595,333 for Interaction Driven Artificial Intelligence System And Uses For Same, Including Travel Or Real Estate Related Contexts by inventors Stillwell, J R., et al., filed Mar. 16, 2022 and issued Feb. 28, 2023, is directed to artificial intelligence systems utilizing a chat driven interface that includes a chat portion and a display portion. The user may interact with the chat portion of the interface in a human understandable and comfortable manner (e.g., through natural language). The artificial intelligence system uses the context of the interactions in the chat portion of the interface to drive the presentation of content in the display portion interface and the chat portion such that the content presented in the display portion of the interface reflects the intents or concepts expressed in the chat portion of the interface, and the chat portion and the display portion of the interface are kept in synchronicity.

### SUMMARY OF THE INVENTION

The present invention relates to a virtual concierge system, and more specifically to an artificial intelligence-aided platform for providing travelers with information about their stay and suggested activities.

It is an object of this invention to provide an artificial intelligence virtual concierge system to provide travelers personalized activities available during their stay.

In one embodiment, the present invention includes a virtual concierge platform for travel information, including a physical object including at least one symbol operable to be scanned by a mobile device, and a server including an artificial intelligence (AI) engine, wherein, upon scanning of the at least one symbol by the mobile device, the AI engine generates an itinerary, wherein the itinerary is based on a location of the physical object, wherein the itinerary is further based on data collected from social media platforms, a survey, a transportation time from a location of the mobile device to a location associated with an itinerary item, seasonal popularity, and/or past ratings, and wherein the itinerary is displayed on a graphical user interface (GUI) on the mobile device.

In another embodiment, the present invention includes a method for providing travel information via a virtual concierge, including providing a physical object including at least one symbol able to be scanned by a mobile device and a server including an artificial intelligence (AI) engine, upon the mobile device scanning the at least one symbol, the AI engine generating an itinerary based in part on a location of the physical object and further based in part on data collected from social media platforms, a survey, a transportation time from a location of the mobile device to a location associated with an itinerary item, seasonal popularity, and/or past ratings, and displaying the itinerary on a graphical user interface (GUI) of the mobile device.

In yet another embodiment, the present invention includes a virtual concierge platform for travel information, including a physical object including at least one symbol operable to be scanned by a mobile device, and a server including an artificial intelligence (AI) engine, wherein the physical object is connected to or includes a power source, wherein the physical object includes internal electronics capable of transferring energy from the power source to the mobile device to charge the mobile device, wherein, upon scanning of the at least one symbol by the mobile device, the AI engine generates an itinerary, wherein the itinerary is based in part on a location of the physical object, wherein the itinerary is further based, in part, on data collected from social media platforms, a survey, transportation time from a location of the mobile device to a location associated with an itinerary item, seasonal popularity, and/or past ratings, and wherein the itinerary is displayed on a graphical user interface (GUI) of the mobile device.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective view of a cube including a visual code according to one embodiment of the present invention.

FIG. 2 illustrates an example welcome page according to one embodiment of the present invention.

FIG. 3 illustrates a property-specific information according to one embodiment of the present invention.

FIG. 4 illustrates travel information according to one embodiment of the present invention.

FIG. 5 illustrates travel information according to another embodiment of the present invention.

FIG. 6 illustrates travel information according to yet another embodiment of the present invention.

FIG. 7 illustrates travel information according to yet another embodiment of the present invention.

FIG. 8 illustrates travel information according to yet another embodiment of the present invention.

FIG. 9 illustrates travel information according to one embodiment of the present invention.

FIG. 10 illustrates travel information according to one embodiment of the present invention.

FIG. 11 illustrates travel information according to another embodiment of the present invention.

FIG. 12 illustrates a virtual concierge system host login according to one embodiment of the present invention.

FIG. 13 is a schematic diagram of a system of the present invention.

### DETAILED DESCRIPTION

The present invention relates to a virtual concierge system, and more specifically to an artificial intelligence-aided platform for providing travelers with information about their stay and suggested activities.

In one embodiment, the present invention includes a virtual concierge platform for travel information, including a physical object including at least one symbol operable to be scanned by a mobile device, and a server including an artificial intelligence (AI) engine, wherein, upon scanning of the at least one symbol by the mobile device, the AI engine generates an itinerary, wherein the itinerary is based on a location of the physical object, wherein the itinerary is further based on data collected from social media platforms, a survey, a transportation time from a location of the mobile device to a location associated with an itinerary item, seasonal popularity, and/or past ratings, and wherein the itinerary is displayed on a graphical user interface (GUI) on the mobile device.

In another embodiment, the present invention includes a method for providing travel information via a virtual concierge, including providing a physical object including at least one symbol able to be scanned by a mobile device and a server including an artificial intelligence (AI) engine, upon the mobile device scanning the at least one symbol, the AI engine generating an itinerary based in part on a location of the physical object and further based in part on data collected from social media platforms, a survey, a transportation time from a location of the mobile device to a location associated with an itinerary item, seasonal popularity, and/or past ratings, and displaying the itinerary on a graphical user interface (GUI) of the mobile device.

In yet another embodiment, the present invention includes a virtual concierge platform for travel information, including a physical object including at least one symbol operable to be scanned by a mobile device, and a server including an artificial intelligence (AI) engine, wherein the physical object is connected to or includes a power source, wherein the physical object includes internal electronics capable of transferring energy from the power source to the mobile device to charge the mobile device, wherein, upon scanning of the at least one symbol by the mobile device, the AI engine generates an itinerary, wherein the itinerary is based in part on a location of the physical object, wherein the itinerary is further based, in part, on data collected from social media platforms, a survey, transportation time from a location of the mobile device to a location associated with an itinerary item, seasonal popularity, and/or past ratings, and wherein the itinerary is displayed on a graphical user interface (GUI) of the mobile device.

None of the prior art discloses a virtual concierge system accessible through scanning a visual code, such as a Quick Response (QR) code or barcode. Traditionally, hotels and resorts hire a concierge, an employee who aids guests in arranging tours, making reservations, and describing the general activities available in the location. However, with the advent of online travel and booking companies, such as AIRBNB, the traveler is deprived of a physical concierge able to provide personalized and informed local recommendations about activities to do or places to visit. The burden of researching where to visit is thus entirely shifted to the traveler.

However, properties rented through alternative booking companies often come with a distinct personal touch, and hosts strive to provide guests with pertinent property information, local recommendations, and other resources to enhance their stay. Traditionally, many hosts have provided a physical book or binder inside their property. This resource typically contains vital information about the property, such as check-in/check-out procedures, WI-FI access details, emergency contacts, and house rules. Furthermore, these books often carry suggestions for local restaurants, attractions, activities, and sights. However, once printed, the information in these books becomes static and often quickly outdated, resulting in incorrect details due to changes in property amenities, or new local attractions being overlooked. Additionally, these physical resources lack personalization and are generic to any traveler who rents the property. As a nonlimiting example, a vegan guest has no use for recommendations to a steak house. Therefore, there is a need for a virtual concierge system to aid travelers in finding activities to participate in during their stay at locations that do not have a physical concierge.

The present invention is directed to an online concierge system, accessed through a QR code printed on a physical object, operable to provide travelers with suggested activities to participate in, locations to travel to, and general information on the area where a rental property is located. The present invention utilizes Artificial Intelligence (AI)/Machine-Learning (ML) to consider both personal data and location information to produce a plurality of suggested activities to participate in during a stay. The AI system utilizes personal data about the user and information about the location subject to the stay to create suggested activities. In one embodiment, the AI system is operable to create an itinerary for the user. As used herein, property refers to a long-term or short-term rental property, house, room, or other location for reservation by individuals for vacation, relocation, or travel purposes. Advantageously, the present invention provides automation for effective vacation rental hosting, allowing the system to run on “autopilot” with a physical product for guests to easily reference without requiring hosts to manually input their own recommendations and regularly update related sites.

Referring now to the drawings in general, the illustrations are for the purpose of describing one or more preferred embodiments of the invention and are not intended to limit the invention thereto.

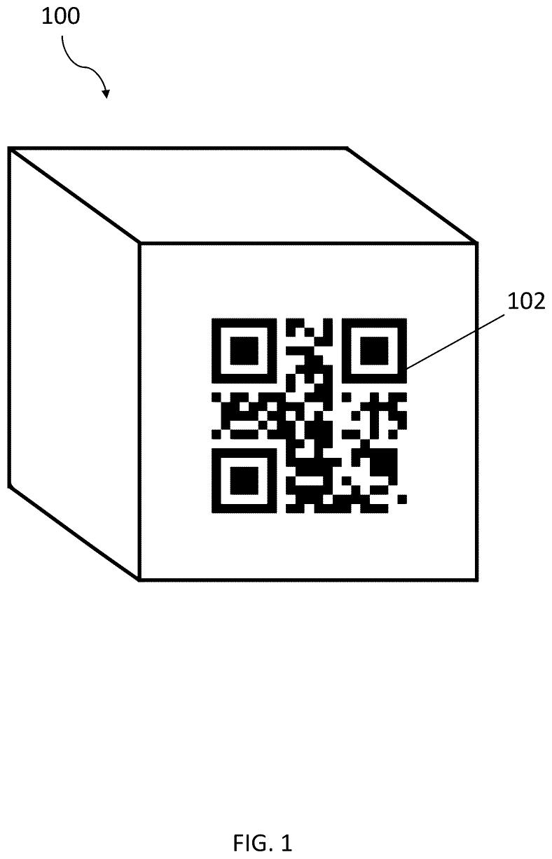

FIG. 1 illustrates a perspective view of a cube 100 according to one embodiment of the present invention. The present invention includes a physical cube 100, with a printed, engraved, or embossed unique visual code 102 (referred to throughout, for convenience, as a QR Code). Scanning the QR code 102 provides the means to electronically access an online platform where the user is presented with a plurality of information. In one embodiment, scanning the QR code 102 enables the user to interact with the platform of the present invention via a Graphical User Interface (GUI) of a display/mobile device (e.g., a smart phone, a tablet, a computer, etc.), which is coupled to a web interface or other suitable interface. In one embodiment, the QR code 102 is operable to be scanned by a camera of a display device and transition the GUI of the mobile device to display information pertaining to the QR code 102. One of ordinary skill in the art will understand that the unique visual code 102 is not limited to a QR code. By way of example and not limitation, in one embodiment, the unique visual code 102 is a barcode, a Near-Field Communication (NFC) tag, a SnapTag (i.e., two-dimensional mobile barcode alternative to a QR code that utilizes an icon, figure, or company logo), an image identifiable through image recognition software, a BLUETOOTH beacon, and/or other machine-readable optical image containing information. Advantageously, by including a QR code 102 directly on the cube 100, the user is provided easy access to the online platform upon accessing the rental location. In one embodiment, the cube 100 is conveniently placed in the location where the user is staying, preferably in an easy to notice location near the front entrance.

In one embodiment the cube 100 is crafted using durable wood (e.g., oak, mahogany, etc.), which is substantially resistant to wear and tear. In one embodiment, the cube's dimensions are approximately 9 cm×9 cm×9 cm, which ensures it is able to easily fit into various property settings without occupying much space. In one embodiment, the QR code 102 is laser-engraved onto two faces of the cube, ensuring longevity and resistance to fading over time. In one embodiment, the engraving depth is approximately 0.5 mm. In one embodiment, the platform is built on a cloud-based architecture, leveraging platforms like AWS or Google Cloud for scalability and reliability. In one embodiment, the platform is operable to utilize advanced encryption techniques, including SSL/TLS protocols, to protect data transmission. Additionally, user data is stored using encryption-at-rest to prevent unauthorized access. In one embodiment, the platform provides a GUI admin page, operable to allow a host of the property to input and/or update property-specific information. In another embodiment, the platform provides a GUI admin page, operable to allow a host of the property to customize a property-specific welcome page displayed on a user device upon the user device scanning a QR code. In one embodiment, the cube 100 is multipurpose and includes functions other than including a QR code 102. In this embodiment, the cube 100 is operable as a night light (by including an internal dimly-lit light), a wireless charger, and/or a BLUETOOTH speaker. In this embodiment, the cube 100 includes internal electronics capable of transferring energy to a mobile device. The cube 100 is operable to include or connect to a power source. In one embodiment, the power source is a wall outlet. In another embodiment, the power source is a battery. In one embodiment, the cube 100 is operable to transfer power from the power source to the mobile device, thus charging the mobile device. In one embodiment, the cube 100 can act as a wireless charger such that when a mobile device is placed on top of cube 100, the cube 100 charges the mobile device. The method of wireless charging includes any method known in the art. In another embodiment, the cube 100 is operable to charge the mobile device via a cable. In one embodiment, the cube 100 includes a tracking chip or other suitable location system operable to track the location of the cube 100, ensuring that it is easier to track and less susceptible to being misplaced.

One of ordinary skill in the art will understand that the shape of the object 100 need not necessarily be a cube but is inclusive of other shapes operable to include a QR code 102 or other unique code or image. As a nonlimiting example, the object 100 is in the shape of a pyramid, a cone, a bird, a person, a sphere, a rectangular prism, a house, a hexagonal prism, and/or any other desirable shape. In one embodiment, scanning the QR code 102 is operable to cause, upon scanning, a display device to display information pertaining to the particular short-term rental property.

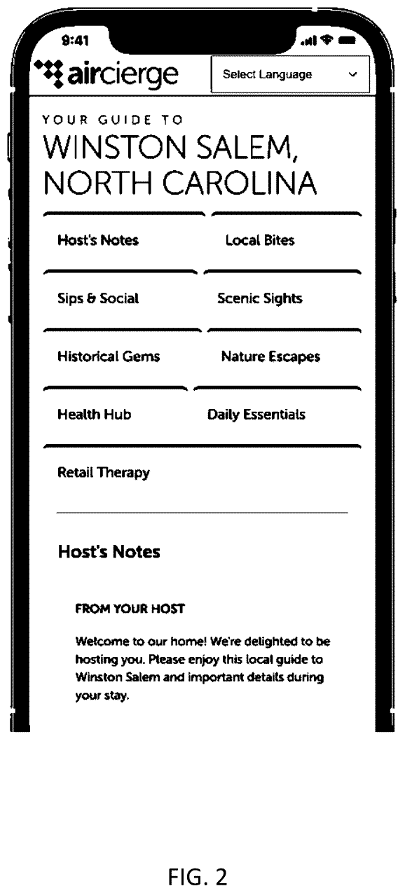

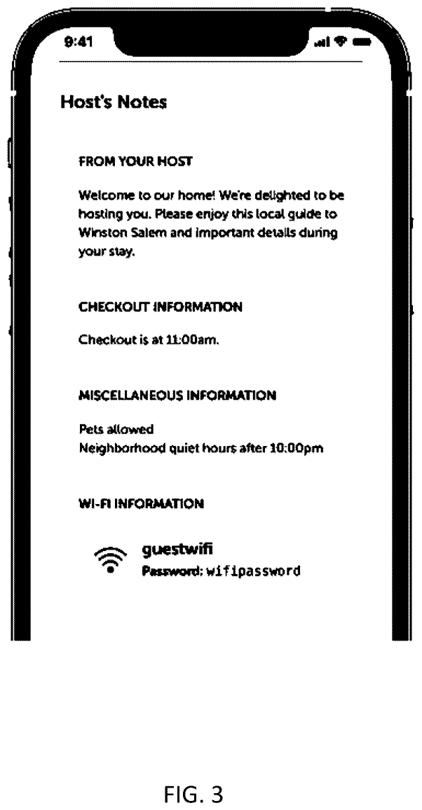

FIG. 2 illustrates a welcome page according to one embodiment of the present invention. In one embodiment, upon scanning the QR code 102, a greeting/welcome GUI page or landing page is displayed including essential property information. The landing page is operable to accommodate any screen size, such that the essential property information is able to be displayed on a tablet, a smart phone, a laptop, and/or any other display device. The landing page is operable to be opened in a mobile application or in a web browser of a mobile device. In one embodiment, the landing page is operable to include a plurality of tiles each with a general information category. In one embodiment, the general information categories include host's notes, local bites, sips & social, scenic sights, historical gems, nature escapes, health hub, daily essentials, retail therapy, and/or any other category travelers may be interested in. Each of the tiles with a general information category are operable to direct a mobile device to more specific information within each category, as depicted in FIGS. 3-11.

FIG. 3 illustrates property-specific information according to one embodiment of the present invention. In one embodiment, the landing page includes a GUI operable to receive property-specific information from at least one server. In one embodiment, the property-specific information includes a customizable message from a property host, check out information, a WI-FI username and password, and/or any other information a host wants displayed. As a nonlimiting example, other information the host wants displayed includes any miscellaneous information. In one embodiment, miscellaneous information includes quiet hours and/or pet accessibility. In one embodiment, the landing page includes a video (e.g., from the owner of the location), providing a welcome message and/or instructions to the user. In this embodiment, the video is displayed upon the first scanning of the QR code 102. In one embodiment, the landing page includes a link to a website and/or a video content streaming site (e.g., a YOUTUBE channel). In one embodiment, the server is operable to send one or more virtual keys to the mobile device upon the mobile device scanning the QR code. The one or more virtual keys provide for access to areas of a property, such as rooms, gated areas, or buildings on a property, and are operable to expire at a check out time or another predetermined time.

The present invention is operable to receive personal data about users from a variety of sources to input into an AI system to create a personal understanding of the user to make travel activity recommendations. In one embodiment, the present invention includes a platform including an application programming interface (API) operable to link to and receive information from a variety of social media platforms (e.g., FACEBOOK, TWITTER, INSTAGRAM, LINKEDIN, YOUTUBE, etc.). Additionally, or alternatively, the system is able to automatically access one or more other apps of the user device used to scan the QR code 102 in order to retrieve user information about one or more users. In one embodiment, upon scanning the QR code 102, a push notification is automatically generated on the user device, operable to receive acceptance or denial of the system accessing information stored on the user device, allowing for personalized privacy settings. In this embodiment, the AI system is operable to collect personal information from the social media platforms, such as age, gender, location, interests, hobbies, familial status, etc. In one embodiment, the AI system is operable to receive personal information about a user through internet cookies associated with the user on the scanning user device. In one embodiment, the platform includes a GUI survey page including a plurality of prompts, operable to receive text-based input. The prompts include questions designed to illicit personal information about the user, expectations and desires related to the trip, and/or practical information about the trip (e.g., need for accommodations, transportation options, stay time, etc.). As a nonlimiting example, a prompt includes “Are you traveling with children?” “Do you have your own mode of transportation?” “What types of activities do you want to do while you're here?” “Are you celebrating a special occasion?” and “Are there any historical sites you wish to visit while you're here?”

In one embodiment, the AI system is operable to collect information about a physical disability of the user, in order to provide recommendations that include proper accommodations (e.g., ramps, elevators, service dog friendly, etc.). In one embodiment, the AI system is operable to collect information about a diet limitation of the user, in order to provide recommendations for restaurants able to accommodate (e.g., vegan, vegetarian, pescatarian, gluten-free, nut allergies, etc.).

In one embodiment, the platform is operable to create a user profile and associate data of a specific user with the user profile. The platform is further operable to provide login credentials in order to enable a user to access a user profile associated with them. In this embodiment, the AI system is operable to associate multiple trips with a single user profile and utilize feedback data and personal data to make future activity suggestions.

In one embodiment, the platform is operable to store local network data such that upon scanning the QR code, the platform is operable to provide WI-FI network identification and password information to a user device. In one embodiment, upon scanning the QR code, the platform is operable to send information about a property in which the physical object is located. The information includes a wireless network password for a wireless network accessible from the property. A GUI on the mobile device provides for the mobile device to connect to the wireless network using the wireless network password upon selection of a GUI element including the wireless network password.

An artificial intelligence module associated with the platform is operable to receive location data associated with the property and automatically generate a list of activities, locations, and/or events in the surrounding area for suggestion purposes. In one embodiment, the AI system is operable to receive location data from an online marketplace for short and long-term homestays and experiences (e.g., AIRBNB, VRBO, VACASA, BOOKINGS.COM, etc.). In one embodiment, upon scanning the QR code of the cube, the platform is operable to receive and/or create location data associated with the physical location of the scanning device (e.g., display device, electronic device, smart phone, etc.). In one embodiment, the location data is created by functionally communicating with a Global Positioning System (GPS) unit of the scanning device. In one embodiment, the present invention is operable to create location data through one or more hardware and/or software components. By way of example and not limitation, location data is created by functionally communicating with a GPS unit of a display device, low energy BLUETOOTH based systems such as beacons, and/or via wireless networks such as WI-FI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

Once the location of the property and/or user device is identified, the AI system is then operable to receive data about activities, locations, and/or events in the general area to create suggested activities. Advantageously, once the location of the property is known, the AI system is operable to collect information about the location and area surrounding the location to determine potential activities, locations, and events that will be of interest to the user, referred to as “local activity information.” In one embodiment, the AI system is operable to utilize a web scraper or web crawler to collect information from websites about the location related to the property. The AI system then utilizes this information to identify areas of interest for the user, including activities to participate in, locations to visit, and/or events to attend. In one embodiment, the AI system is operable to utilize a large language model to generate descriptions of local activities or locations, and/or explanations of why they are recommended based on reviews of the activities and/or locations and/or the user's personal preference information. In one embodiment, activities and/or locations include local scenic sights, nature destinations, local restaurants, grocery stores, historical sites, and/or publicly owned destinations such as museums, parks, and/or libraries. User personal preference information is operable to be determined by prior user ratings for activities stored in one or more mobile applications, or one or more websites, or one or more social media platforms. For example, user personal preferences are operable to be determined based on analysis of prior AIRBNB profiles and/or reviews, FACEBOOK or LINKEDIN profiles and/or posts, prior reservations made through a website or application (such as RESY or OPENTABLE reservations), or GOOGLE, TRIPADVISOR, or YELP reviews. In one embodiment, the analysis is automated and uses AI, LLM, or ML.

The AI system of the present invention is operable to consider at least the personal data collected, the location data collected, and local activity information in order to create suggested activities to the user. The AI system is operable to create an understanding of the user, such that the suggested activities are personally tailored to the specific user. The AI system is operable to consider the personalized data and compare it with available activities in the area, such that the plurality of suggested activities are related to the personal data of the user and the local activity information. Advantageously, the AI system not only provides suggested activities that are personally tailored to the user (i.e., likely to be a desirable activity), but the AI system is also operable to consider the practical constraints of the user. As a nonlimiting example, the AI system is operable to consider practical constraints such as accessibility, transportation options, dietary restrictions, age-appropriateness, distance, timeline, and/or practical constraints. In one embodiment, the AI system is operable to create an itinerary. The itinerary includes a plurality of activities organized by data and time. In one embodiment, the itinerary includes a plurality of suggested activities organized chronologically, without specific times. In one embodiment, the itinerary includes a plurality of alternative suggested activities, such that the user has more than one activity to choose from for a specific time.

In one embodiment, the platform includes at least one integrated booking API for car services (e.g., UBER, LYFT, etc.), venue ticket purchase (e.g., TICKETMASTER, FANDANGO, etc.), restaurant booking (e.g., OPENTABLE, etc.), and/or any other third-party booking system. This allows users to quickly manage their stays through a single app or website, rather than switching between a variety of apps.

In one embodiment, the AI system includes a large language model trained using datasets including, but not limited to, travel reviews, location and/or event descriptions, local attraction advisories, global events, and geographical nuances. In one embodiment, the dataset is updated daily, weekly, monthly, and/or yearly to include recent and changing data. In one embodiment, the AI system is operable to cache results, suggested activities, and/or created itineraries. In one embodiment, the cached data is stored in a compressed format. In one embodiment, cached itineraries are updated according to a trigger. In one embodiment, updating includes providing new suggested activities, deleting old suggested activities, and/or updating suggested activities. In one embodiment, the trigger is time-based, such that upon a predetermined length of time occurring the trigger is initiated. In one embodiment, the trigger is location-based (e.g., based on a geofenced zone), such that upon the user entering a new city, the trigger is initiated. In one embodiment, the large language model of the AI system is trained based on information from large textual datasets from online websites such as WIKIPEDIA, GITHUB, and/or other text-based data sources known in the art and/or based on information from posts on social media websites (e.g., FACEBOOK, TWITTER, TUMBLR, REDDIT, etc.).

In one embodiment, the AI system includes a feedback loop, where the AI system is operable to consider previously created suggested activities and associated success rates as an input to be considered for future outputs and/or suggested activities. In one embodiment, a GUI of the platform includes the means for a user to provide feedback as to whether the suggested activities where helpful in planning their trip, whether the user actually participated in the suggested activity, and/or whether the user considered the suggested activity desirable. In this embodiment, the AI system is operable to consider this feedback for future suggestions. As a nonlimiting example, a particularly popular activity (i.e., one which has been indicated as helpful or successful on more than one occasion) is suggested more frequently than others. In one embodiment, a GUI of the platform includes at least one text box and/or one or more selectable buttons for a user to provide feedback as to whether they actually participated in the suggested activity and to rate the activity. In one embodiment, the rating is on a scale of one to ten, where ten indicates a highly desirable activity and one indicates a non-desirable activity, but one of ordinary skill in the art will understand that other rating systems and scales are also compatible with the present invention (e.g., a five-star system). The AI system is operable to consider the rating of previously suggested activities and either provide the same suggested activity more frequently, less frequently, always, and/or not at all, based in part on the rating. In one embodiment, the platform is operable to make the user-provided feedback available to an admin of the specific location, such that the host or owner of the property is provided the feedback alongside the AI system.

In one embodiment, the AI system is trained, in part, based on previous ratings for particular activities. In one embodiment, these previous ratings are correlated with particular personal traits of the rater (e.g., gender, ethnicity, age, religion, interests, etc.) in order to build a profile of individuals who typically enjoy a particular activity or location. In one embodiment, the AI system is trained based on previous attendance rates for particular suggested events based on either self-reported attendance on events suggested on an itinerary, or geolocation tracking of a user device to automatically determine if an event was attended. In one embodiment, the order of the itinerary or which events or activities are listed on the itinerary is informed based on abnormal rates of previous users stopping their trips or going home after particular events (e.g., users tend to go home after visiting a particular museum in order to rest). In one embodiment, average amount of time for each event and/or location is generated based on previous user data, based on either manual reporting or geolocation-based tracking, optionally correlated with particular user traits such as age, gender, and/or other traits. In one embodiment, the AI system is trained to determine seasonal variations in popularity of particular events and/or activities in order to determine whether to add the event to the itinerary, the order of the itinerary, the estimated time for particular events, and/or other properties of the itinerary.

In one embodiment, the AI system is operable to access and train based on local public transportation system (e.g., bus, metro, etc.) timetables and routes. Incorporating public transportation system location in generating an itinerary helps to determine natural flow of activities or locations, as the raw distance between locations is often insufficient to determine the actual time or cost needed to travel between the locations. In one embodiment, the AI system is operable to receive a selection from a user device to use, use exclusively, or not use public transportation in order to inform the AI system's selections.

In one embodiment, the AI system includes a chat bot operable to simulate a conversation between a user and the AI system. In this embodiment, the chat bot is operable to provide a questionnaire about the user and their expectations and answer the use such that a conversation is simulated. In one embodiment, the chat bot is operable to receive questions and/or conversation prompts from the user regarding particular types of activities or locations the user is interested in and provides natural language responses and/or links for particular activities or locations in response.

In one embodiment, recommendations produced by the system and guides for particular homestays are able to be translated into any language based on preferences of the user and/or based on a set language of the user device used to scan the QR code. In one embodiment, the system is operable to translate recommendations into at least 100 different languages.

One of ordinary skill in the art will understand that the present invention is able to be utilized for a variety of types of rental-based accommodations, including vacation rental homes, hotels, motels, and/or other locations, including, but not limited to, ticketed travel locations, such as planes, trains, and/or ships.

In one embodiment, the present invention, upon scanning the QR code, is operable to display an Augmented Reality (AR) view of the landing page. In one embodiment, the system includes a headset configured for virtual reality, augmented reality, and/or mixed reality environments (AR/VR). In one embodiment, the AR and/or VR system is operable to generate a 360-degree rendered space corresponding to one or more of the recommended activities or locations in order to provide more informed decisions regarding optimal locations to visit or activities to engage in. The headset is configured to receive and display an image of a virtual scene, movie, and/or environment corresponding to one or more activities or locations.

The headset preferably includes a display, an eyewear component, at least one power supply component, at least one image capturing device, and/or control electronics. In one embodiment, the headset is a pair of goggles. Alternatively, the headset is a pair of glasses. In one embodiment, the headset includes at least one strap and/or temples. In one embodiment, the power supply component includes at least one battery, at least one supercapacitor, or other similar power supply components. In another embodiment, the battery includes at least one rechargeable battery. In yet another embodiment, the at least one rechargeable battery includes a lithium ion battery.

The headset is further operable to receive audio data and communicate the audio data to a wearer via a speaker, headphones, and other similar audio playback devices. In one embodiment, the headphones are noise-cancelling headphones. The noise-cancelling headphones are configured to block out external noise such that the wearer is completely immersed in the AR/VR environment.

Examples of headsets and/or AR/VR systems include, but are not limited to, those described in U.S. Pat. Nos. 8,217,856; 8,743,145; 9,094,677; 9,223,136; 9,635,450; 9,671,614; 9,733,480; 9,734,402; 9,766,462; 9,846,483; 9,858,703; 9,897,812; 9,989,998; 10,025,060; 10,037,084; 10,055,645; 10,055,887; 10,061,352; 10,061,391; 10,082,672; 10,102,674; 10,122,990; 10,124,251; 10,133,305; 10,185,390; 10,209,769; 10,244,226; 10,254,547, each of which is incorporated herein by reference in its entirety.

The present invention is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The present invention is operable to use any of the aforementioned learning techniques alone or in combination.

Further, the present invention is operable to utilize predictive analytics techniques including, but not limited to, machine learning (ML), artificial intelligence (AI), neural networks (NNs) (e.g., long short-term memory (LSTM) neural networks), deep learning, historical data, and/or data mining to make future predictions and/or models. The present invention is preferably operable to recommend and/or perform actions based on historical data, external data sources, ML, AI, NNs, and/or other learning techniques. The present invention is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

Location data is created in the present invention using one or more hardware and/or software components. By way of example and not limitation, location data is created using the Global Positioning System (GPS), low energy BLUETOOTH based systems such as beacons, wireless networks such as WI-FI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

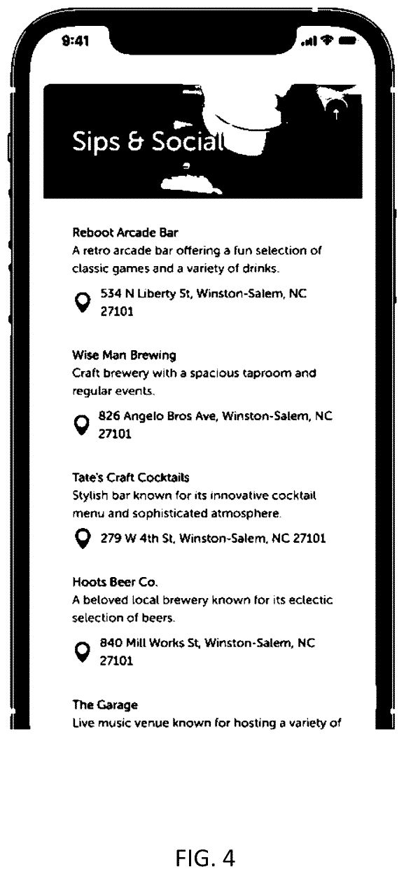

FIG. 4 illustrates a virtual concierge platform including travel information generated by an AI engine according to one embodiment of the present invention. The “Sips & Social” information category is operable to appear on a welcome page of a GUI on a mobile device. Upon selection of the “Sips & Social” information category on the mobile device, the virtual concierge platform directs the mobile device to the specific travel information for “Sips & Social.” In one embodiment, the specific travel information includes a name of a location serving food and/or drinks. The specific travel information further includes a brief description of the location, generated by the AI engine. In one embodiment, the specific travel information further includes an address of the location. Upon a mobile device selecting the address, the virtual concierge platform is operable to automatically access a mapping application on the mobile device and map a route from the mobile device's current location to the address selected by the mobile device. In one embodiment, the specific travel information appears hierarchically. The specific information hierarchy depends in part on information obtained by the AI engine, where the AI engine displays the specific travel information according to which location matches most closely to information obtained by the AI engine, such as social media data, user ratings, and/or any other information. In another embodiment, the specific travel information appears in alphabetical order. In another embodiment, the specific travel information appears based on distance from the mobile device to the location. In another embodiment, specific travel information appears randomly.

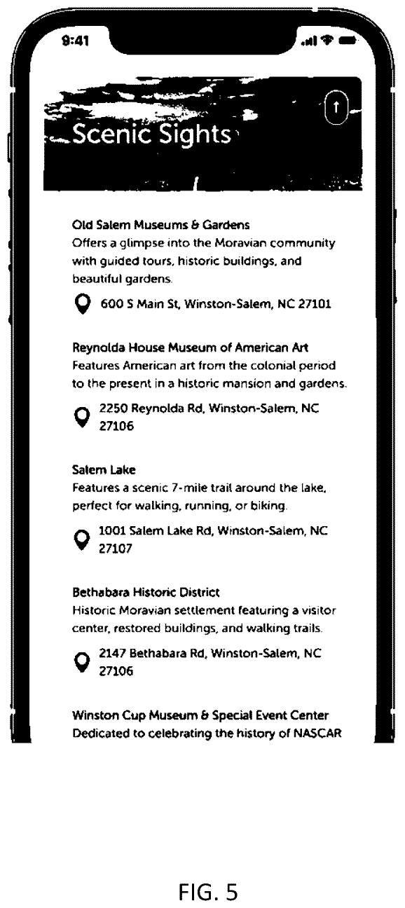

In one embodiment, depicted in FIG. 5, a virtual concierge platform including travel information generated by an AI includes a “Scenic Sights” information category. The “Scenic Sights” information category is operable to appear on a welcome page of a GUI on a mobile device. Upon selection of the “Scenic Sights” information category on the mobile device, the virtual concierge platform directs the mobile device to the specific travel information for “Scenic Sights.” The specific travel information for “Scenic Sights” is operable to include all details and functionality of the “Sips & Social” information category discussed herein. In one embodiment, the “Scenic Sights” travel information category is operable to include museums, gardens, art galleries, lakes, historic districts, and/or any other scenic destination.

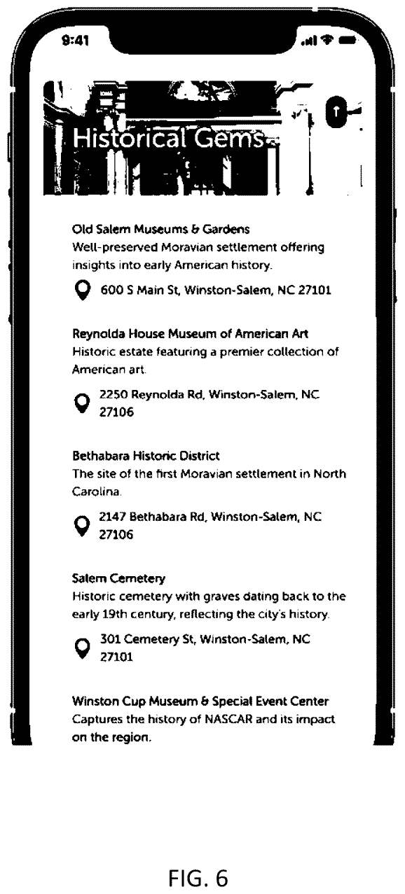

In one embodiment, depicted in FIG. 6, a virtual concierge platform including travel information generated by an AI includes a “Historical Gems” information category. The “Historical Gems” information category is operable to appear on a welcome page of a GUI on a mobile device. Upon selection of the “Historical Gems” information category on the mobile device, the virtual concierge platform directs the mobile device to the specific travel information for “Historical Gems.” The specific travel information for “Historical Gems” is operable to include all details and functionality of the “Sips & Social” information category discussed herein. In one embodiment, the “Historical Gems” travel information category is operable to include museums, cemeteries, gardens, art galleries, lakes, historic districts, and/or any other historical destination.

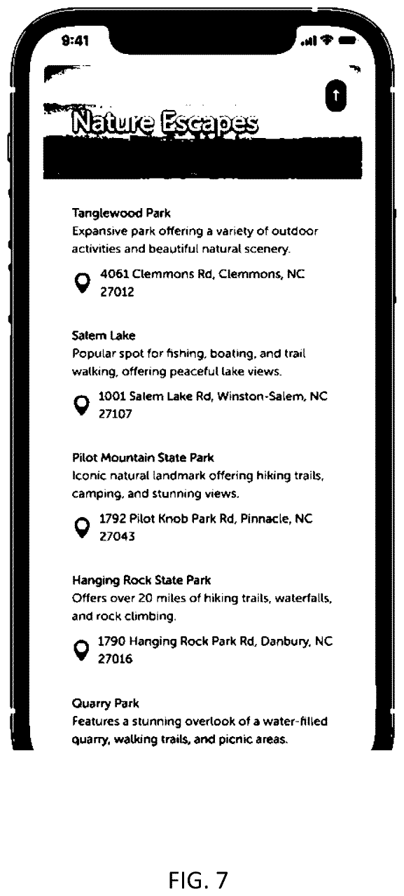

In one embodiment, depicted in FIG. 7, a virtual concierge platform including travel information generated by an AI includes a “Nature Escapes” information category. The “Nature Escape” information category is operable to appear on a welcome page of a GUI on a mobile device. Upon selection of the “Nature Escapes” information category on the mobile device, the virtual concierge platform directs the mobile device to the specific travel information for “Nature Escapes.” The specific travel information for “Nature Escapes” is operable to include all details and functionality of the “Sips & Social” information category discussed herein. In one embodiment, the “Nature Escapes” travel information category includes parks, lakes, rivers, streams, ponds, state parks, national parks, and/or any other non-manmade destinations.

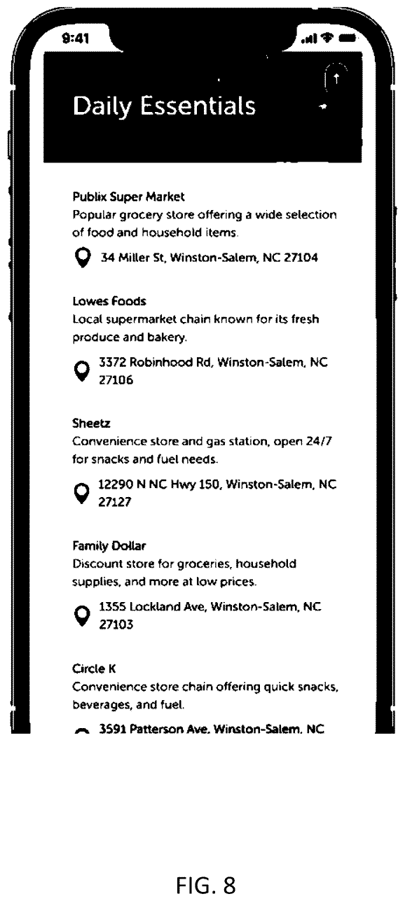

In one embodiment, depicted in FIG. 8, a virtual concierge platform including travel information generated by an AI includes a “Daily Essentials” information category. The “Daily Essentials” information category is operable to appear on a welcome page of a GUI on a mobile device. Upon selection of the “Daily Essentials” information category on the mobile device, the virtual concierge platform directs the mobile device to the specific travel information for “Daily Essentials.” The specific travel information for “Daily Essentials” is operable to include all details and functionality of the “Sips & Social” information category discussed herein. In one embodiment, the “Daily Essentials” travel information category is operable to include grocery stores, supermarkets, gas stations, convenient stores, dollar stores, and/or any other location commonly visited by an average consumer.

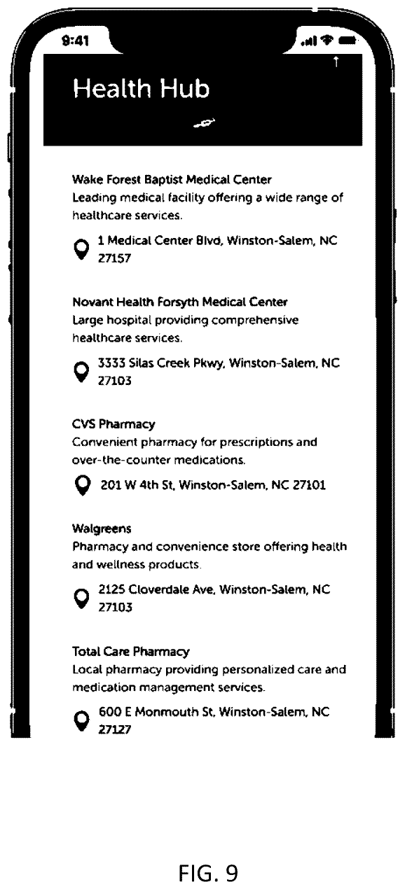

In one embodiment, depicted in FIG. 9, a virtual concierge platform including travel information generated by an AI includes a “Health Hub” information category. The “Health Hub” information category is operable to appear on a welcome page of a GUI on a mobile device. Upon selection of the “Health Hub” information category on the mobile device, the virtual concierge platform directs the mobile device to the specific travel information for “Health Hub.” The specific travel information for “Health Hub” is operable to include all details and functionality of the “Sips & Social” information category discussed herein. In one embodiment, the “Health Hub” travel information category is operable to include medical centers, hospitals, pharmacies, wellness centers, spas, gyms, psychiatrists, therapists, and/or any other location operable to increase an individual's wellbeing.

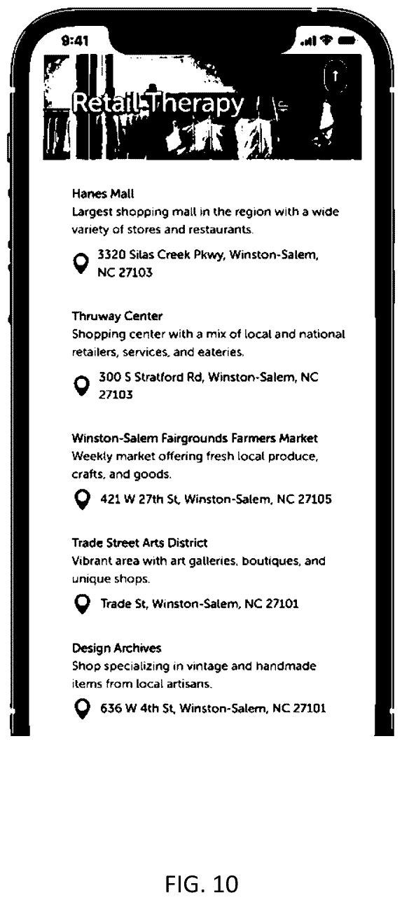

In one embodiment, depicted in FIG. 10, a virtual concierge platform including travel information generated by an AI includes a “Retail Therapy” information category. The “Retail Therapy” information category is operable to appear on a welcome page of a GUI on a mobile device. Upon selection of the “Retail Therapy” information category on the mobile device, the virtual concierge platform directs the mobile device to the specific travel information for “Retail Therapy.” The specific travel information for “Retail Therapy” is operable to include all details and functionality of the “Sips & Social” information category discussed herein. In one embodiment, the “Retail Therapy” travel information category is operable to include outlet malls, shopping malls, strip malls, farmers markets, trade districts, shops, and/or any other retail location.

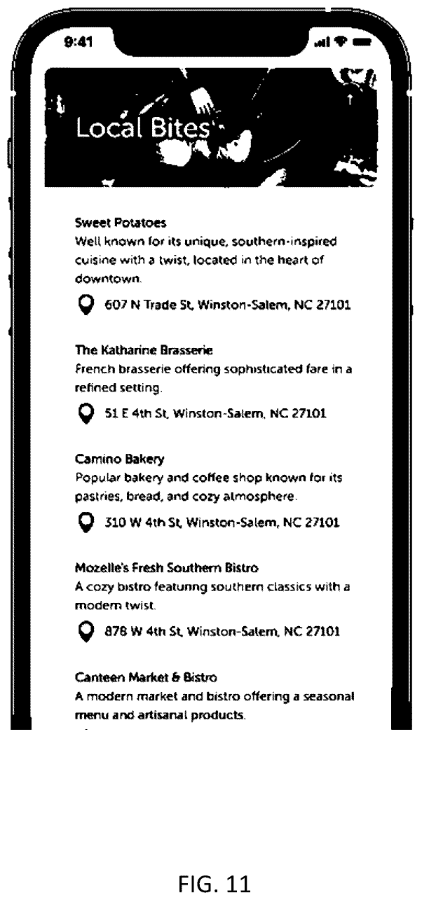

In one embodiment, depicted in FIG. 11, a virtual concierge platform including travel information generated by an AI includes a “Local Bites” information category. The “Local Bites” information category is operable to appear on a welcome page of a GUI on a mobile device. Upon selection of the “Local Bites” information category on the mobile device, the virtual concierge platform directs the mobile device to the specific travel information for “Local Bites.” The specific travel information for “Local Bites” is operable to include all details and functionality of the “Sips & Social” information category discussed herein. In one embodiment, the “Local Bites” travel information category is operable to include restaurants, bakeries, bistros, pubs, eateries, and/or any other location serving food.

Although several travel information categories have been discussed herein, each embodiment is not intended to limit the present invention, merely provide examples. A virtual concierge platform according to the present invention is operable to include any number of information categories.

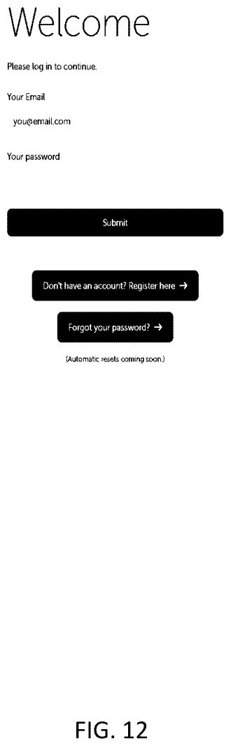

A virtual concierge platform according to the present invention is operable to include a host login page, where the host can update information, change property-specific information, change a welcome message, and/or customize travel information displayed on a mobile device upon scanning a QR code. FIG. 12 illustrates a host login page according to one embodiment of the present invention. A host login page allows further customization and added security. The host login page prevents guests from changing travel information and property specific information, unlike traditional travel binders that guests can edit and/or destroy during the guest's stay.

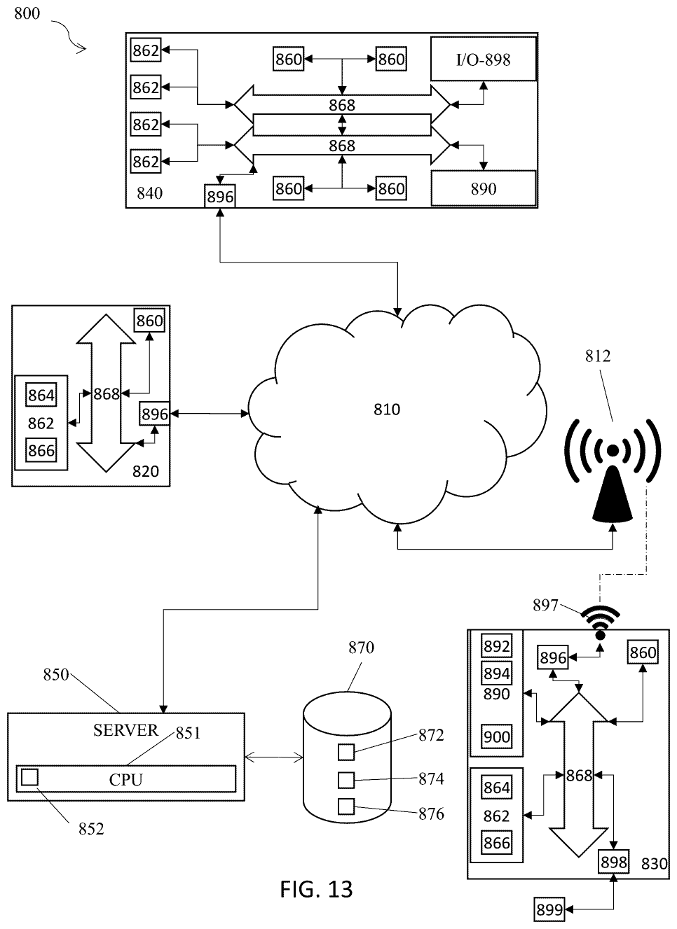

FIG. 13 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 13, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 13, is operable to include other components that are not explicitly shown in FIG. 13, or is operable to utilize an architecture completely different than that shown in FIG. 13. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A virtual concierge platform for travel information, comprising:
a physical object including at least one symbol operable to be scanned by a mobile device; and
a server including an artificial intelligence (AI) engine;
wherein, upon scanning of the at least one symbol by the mobile device, the AI engine generates an itinerary;
wherein the itinerary is based on a location of the physical object;
wherein the itinerary is further based on data collected from social media platforms, a survey, a transportation time from a location of the mobile device to a location associated with an itinerary item, seasonal popularity, and/or past ratings; and
wherein the itinerary is displayed on a graphical user interface (GUI) on the mobile device.

2. The platform of claim 1, wherein the at least one symbol includes at least one Quick Response (QR) code.

3. The platform of claim 1, wherein the AI engine includes a large language model, wherein the large language model is operable to generate descriptions of events in the itinerary, wherein the descriptions of the events in the itinerary are displayed via the GUI on the mobile device.

4. The platform of claim 1, wherein the server is operable to send information about a property in which the physical object is located, wherein the information includes a wireless network password for a wireless network accessible from the property, and wherein the GUI on the mobile device provides for the mobile device to connect to the wireless network using the wireless network password upon selection of a GUI element including the wireless network password.

5. The platform of claim 1, wherein the GUI includes an address for each activity of the itinerary, wherein activation of the address via the GUI opens a map application on the mobile device including directions from the location of the mobile device to a location of the activity.

6. The platform of claim 1, wherein the AI engine is operable to receive feedback and update the itinerary based at least in part on the feedback.

7. The platform of claim 1, wherein the AI engine updates the data collected from the social media platforms, the survey, the transportation time from the location of the mobile device to the location associated with the itinerary item, the seasonal popularity, and/or the past ratings at predetermined intervals.

8. The platform of claim 1, wherein the physical object includes a global positioning system (GPS) sensor.

9. A method for providing travel information via a virtual concierge comprising:
providing a physical object including at least one symbol able to be scanned by a mobile device and a server including an artificial intelligence (AI) engine;
upon the mobile device scanning the at least one symbol, the AI engine generating an itinerary based in part on a location of the physical object and further based in part on data collected from social media platforms, a survey, a transportation time from a location of the mobile device to a location associated with an itinerary item, seasonal popularity, and/or past ratings; and
displaying the itinerary on a graphical user interface (GUI) of the mobile device.

10. The method of claim 9, further comprising the physical object charging the mobile device.

11. The method of claim 9, wherein the physical object includes a global positioning system (GPS) sensor.

12. The method of claim 9, wherein the at least one symbol includes at least one Quick Response (QR) code.

13. The method of claim 9, wherein the AI engine includes a large language model.

14. The method of claim 13, further comprising the large language model generating descriptions of events in the itinerary and displaying the descriptions of the events in the itinerary on the GUI of the mobile device.

15. The method of claim 9, further comprising the AI engine updating the data collected from the social media platforms, the survey, the transportation time from the location of the mobile device to the location associated with the itinerary item, the seasonal popularity, and/or the past ratings at predetermined intervals.

16. The method of claim 9, wherein the physical object is a cube, a pyramid, a cone, a sphere, a rectangular prism, a house, and/or a hexagonal prism.

17. A virtual concierge platform for travel information comprising:
a physical object including at least one symbol operable to be scanned by a mobile device; and
a server including an artificial intelligence (AI) engine;
wherein the physical object is connected to or includes a power source;
wherein the physical object includes internal electronics capable of transferring energy from the power source to the mobile device to charge the mobile device;
wherein, upon scanning of the at least one symbol by the mobile device, the AI engine generates an itinerary;
wherein the itinerary is based in part on a location of the physical object;
wherein the itinerary is further based, in part, on data collected from social media platforms, a survey, transportation time from a location of the mobile device to a location associated with an itinerary item, seasonal popularity, and/or past ratings; and
wherein the itinerary is displayed on a graphical user interface (GUI) of the mobile device.

18. The platform of claim 17, wherein the AI engine includes a large language model.

19. The platform of claim 18, wherein the large language model is operable to generate descriptions of events in the itinerary, wherein the descriptions of the events in the itinerary are displayed via the GUI.

20. The platform of claim 17, further comprising a GUI admin page operable to customize a property-specific welcome page displayed on the GUI of the mobile device upon the scanning of the at least one symbol by the mobile device.
